(19) United States
(12) Patent Application Publication
(10) Pub. No.: US 2026/0276438 A1
(43) Pub. Date: Sep. 17, 2026

(54) High-Definition Distributed Fiber Optic Sensing (HD-DFOS) for Smart Intersection and Road Conditions Diagnostics

(71) Applicant: NEC Laboratories America, Inc., Princeton, NJ (US)

(72) Inventors: Yuheng Chen, South Brunswick, NJ (US); Azita Nouri, Highland Park, NJ (US); Ming-Fang Huang, Princeton, NJ (US); Yue Tian, Princeton, NJ (US); Ting Wang, West Windsor, NJ (US)

(21) Appl. No.: 19/562,595

(22) Filed: Mar. 10, 2026

Related U.S. Application Data
(60) Provisional application No. 63/769,976, filed on Mar. 11, 2025.

(51) Int. Cl. G01H 9/00; E01C 23/01; G01D 5/353; G08G 1/01

(52) U.S. Cl. CPC G01H 9/004; E01C 23/01; G01D 5/35361; G08G 1/0116

(57) ABSTRACT

A high-definition distributed fiber optic sensing (HD-DFOS) system and method for traffic monitoring and road condition diagnostics. The system utilizes optical fibers deployed along roadsides to capture high-temporal-resolution vibrational signals, capturing thousands of frames per second to clearly identify ground vibration wavefronts. A high-performance, multi-process computational platform utilizing shared memory converts 16-bit multi-channel transient traces into pseudo-color RGB images. A “You Only Look Once” (YOLO) object detection model is applied to the pseudo-color images to classify the sources of mechanical disturbances, distinguishing between vehicle-induced vibrations, ambient ground disturbances, and impacts with surface defects like potholes or cracks in real-time

### CROSS REFERENCE TO RELATED APPLICATIONS

This application claims the benefit of U.S. Provisional Patent Application Ser. No. 63/769,976 filed Mar. 11, 2025, the entire contents of which is incorporated by reference as if set forth at length herein.

### FIELD OF THE INVENTION

The present invention relates generally to Distributed Fiber Optic Sensing (DFOS) technology. More particularly, the invention relates to traffic monitoring and road condition diagnostics using high-definition distributed fiber optic sensing (HD-DFOS) and machine learning for real-time event detection and classification.

### BACKGROUND OF THE INVENTION

Intersections are notorious for traffic accidents, many of which are caused by vehicle violations, such as running red lights or ignoring stop signs, or by blind spots, such as sharp roadway turns or obstructed views. Additionally, intersections often act as bottlenecks for traffic flow.

Given that optical fibers have been successfully deployed along roadsides, utilizing fiber optic sensing technologies offers a practical approach to obtaining a holistic view of traffic conditions particularly at intersections. By leveraging these technologies, both the safety and efficiency of intersections within the network of roadways may be enhanced.

As those skilled in the art will understand and appreciate, single optical fibers deployed along roadways can cover up to a 100 km range and provide a cost-effective solution compared to cameras, existing fiber optic sensing technologies exhibit certain limitations. For example, while first-generation DFOS systems provided up to 32,000 sensing points to monitor vibrational activity, the temporal resolution of these early systems was limited due to throughput constraints, typically achieving only a few frames per second, such as 8 frames per second. And while these systems could detect and localize vibrations along the fiber, they faced significant challenges in classifying the source or category of mechanical disturbances, making it oftentimes difficult to differentiate between vehicle-induced vibrations and ambient ground disturbances

### SUMMARY OF THE INVENTION

An advance in the art is made according to aspects of the present invention directed to a system and method that monitors traffic flow and detects and reports abnormal road conditions such as potholes, cracks, or other surface defects that enables roadway managers to receive real-time information about roadway conditions and undertake prompt corrective action as required. Additionally, such conditions may advantageously be provided to vehicles on roadways through web-based services, such as block-chain technologies, thereby ensuring drivers (or self-driving vehicles) are informed and can adjust their route(s) or driving behavior(s) as necessary or desired.

In sharp contrast to the prior art, the present invention includes a high-definition distributed fiber optic sensing (HD-DFOS) system to monitor traffic flow and detect abnormal road conditions, such as potholes, cracks, or other surface defects. An HD-DFOS interrogator captures vibration patterns at a much higher temporal resolution than prior art systems, capturing thousands of frames per second of vibrational signals. This substantial increase in temporal resolution allows for the clear identification of distinct vibrational signatures.

To process this data, the system according to the present invention utilizes a high-performance computational platform comprising a multi-process, multi-thread manager to handle HD-DFOS data streaming. A YOLO (You Only Look Once) object detection algorithm is employed to distinguish vehicle-induced vibration patterns from other ambient ground vibrations and detect events where vehicles traverse road surface defects. The system converts tempo-spatial DFOS plots into pseudo-color RGB images to train and deploy the customized YOLO model for real-time event detection.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative intersection having poor visibility of approaching traffic due to a blind spot at the left of the diagram according to aspects of the present invention.

FIG. 3 is a schematic diagram showing an application scenario at an intersection according to aspects of the present invention.

FIG. 4(A), FIG. 4(B), FIG. 4(C), FIG. 4(D), FIG. 4(E), and FIG. 4(F) show received vehicle traces from two DFOS system in which: a pair of reliability diagrams in which: FIG. 4(A) a waterfall plot of vehicle trace with low temporal resolution; FIG. 4(B) is a trace of the same vehicle from a high-definition DFOS; FIG. 4(C) is a pounding ground snapshot; FIG. 4(D) is a continuous hammer drill action snap shot; FIG. 4(E) is a zoomed in pattern of vehicle passing, and FIG. 4(F) is a Rayleigh wavefront model and resulting DFOS pattern all according to aspects of the present disclosure.

FIG. 5 is a schematic diagram showing an illustrative software architecture for high definition DFOS streaming and detection according to aspects of the present invention.

FIG. 6 is a schematic diagram showing illustrative data processing pipeline according to aspects of the present invention.

FIG. 7 is a schematic diagram showing illustrative model training according to aspects of the present invention.

FIG. 8 is a schematic diagram showing illustrative real-time event detection framework according to aspects of the present invention.

FIG. 9 is a schematic diagram showing illustrative model training according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and depending on system configuration-can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

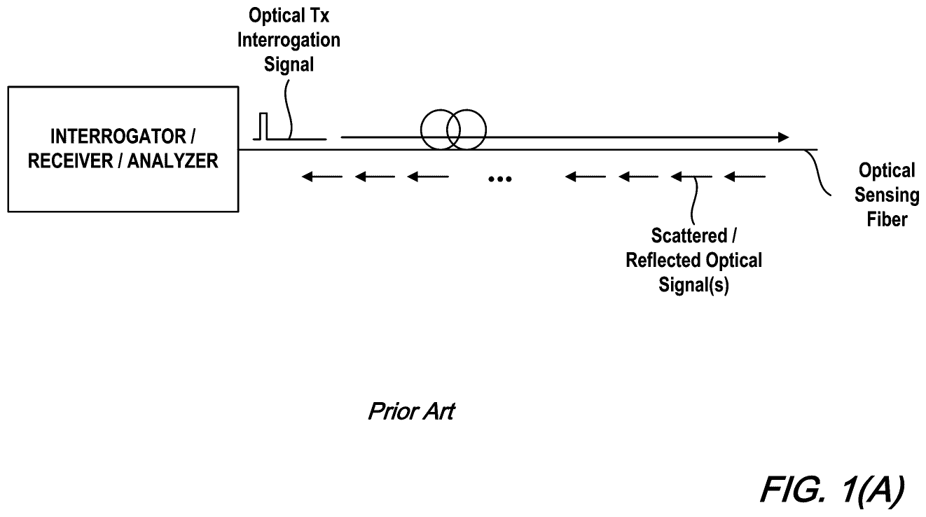

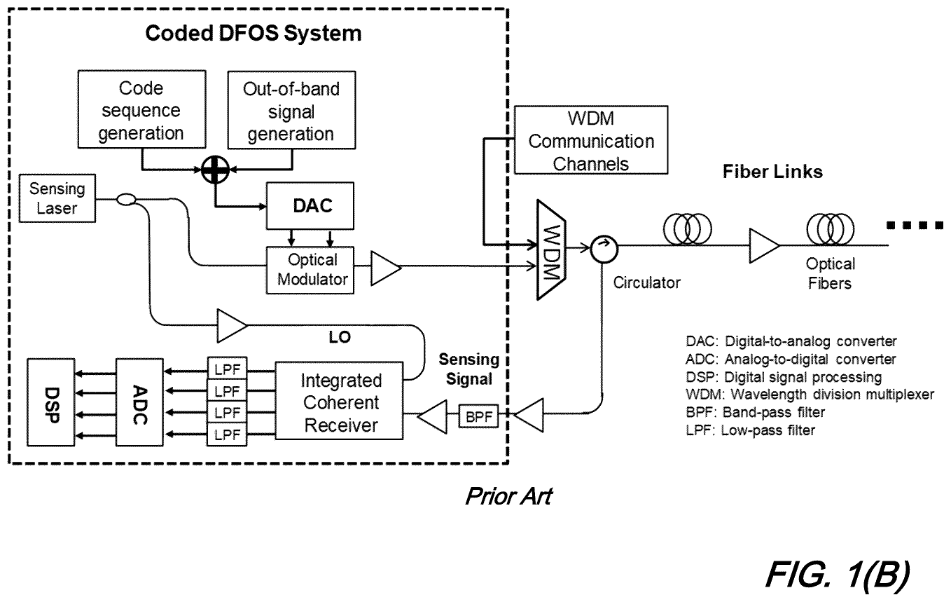

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As we shall show and describe and as those skilled in the art will understand and appreciate, the present invention leverages optical fibers that are or can be deployed along roadsides to gain a holistic view of traffic conditions. The deployed fiber sensing technology serves as an additional safeguard by detecting approaching vehicles and allowing for real-time monitoring and responses to potential hazards, significantly reducing traffic accidents.

The system detects mechanical disturbances and ground movements based on surface wave propagation. Any source with a vertical action will primarily generate Rayleigh waves. Activities such as a vehicle running or digging generate this type of surface wave. Because vehicle movement generally creates a lower pitch than construction machinery, and impulse sources like pounding generate dispersive waves due to their aperiodic features, the sources can be distinctively classified.

The system utilizes a high-definition distributed fiber optic sensing (HD-DFOS) interrogator capable of capturing thousands of frames per second. In a preferred embodiment, the HD-DFOS captures raw waveform images at a refresh rate of at least 1000 frames per second, compared to the approximately 8 frames per second captured by first-generation “waterfall” plot recordings. At this high temporal resolution, the wavefront of ground vibrations generated by a vehicle is clearly visible.

To handle the streaming of high-definition data, a high-performance computational platform is utilized, incorporating a multi-process and multi-thread manager. The DFOS retrieves phase variations along the fiber and transfers the raw Distributed Acoustic Sensing (DAS) data via an Ethernet cable into a volatile shared memory buffer. Various processes, such as Digital Signal Processing (DSP) routines, access the raw data and output to an intermediate data stage. Machine learning processes access this intermediate data to produce interference results, such as anomaly detections, which are also stored in the volatile shared memory. Communication between these concurrent processes occurs through designated message queues.

For event classification, a customized YOLO (You Only Look Once) computer vision model is utilized. The tempo-spatial DFOS plot, initially represented as a 16-bit digitized, multi-channel transient trace, is converted into pseudo-color RGB images. These images are labeled by cropping patterns corresponding to different events (e.g., vehicle traces, hammer drills, single pounding) to train the YOLO model. For a repetition rate of 1000 Hz across 4000 sensing channels, the model's inference time is less than 10 milliseconds for scanning a 500×4000 patch, which represents a 0.5-second duration. In further embodiments, multi-channel vibration signals are converted into Mel-frequency cepstral coefficients (MFCCs) to train the classifier. Detected road defects can be reported in real-time to road operators and broadcast to vehicles using web-based services, including blockchain technology

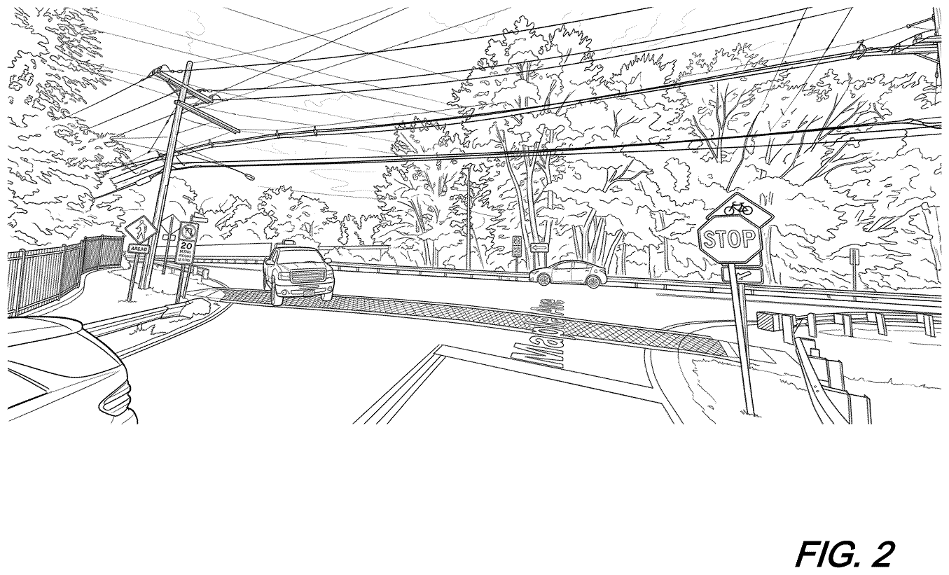

FIG. 2 is a schematic diagram showing an illustrative intersection having poor visibility of approaching traffic due to a blind spot at the left of the diagram according to aspects of the present invention.

As we have noted and readily understood, intersections are notorious for traffic accidents, many of which are caused by either vehicle violations such ignoring traffic signals/signs/instructions, or by blind spots such as sharp roadway turns or objected views such as that shown in FIG. 2.

Given that optical fibers can be (or have already been) deployed along roadsides, utilizing fiber optic sensing technology offers a practical approach to gaining a holistic view of traffic conditions. By leveraging this technology, we advantageously enhance both the safety and the efficiency of intersections within a roadway network. Compared to cameras, a single optical fiber can provide monitoring coverage up to 100 km range, which provides a cost-effective solution for smart city applications, among others.

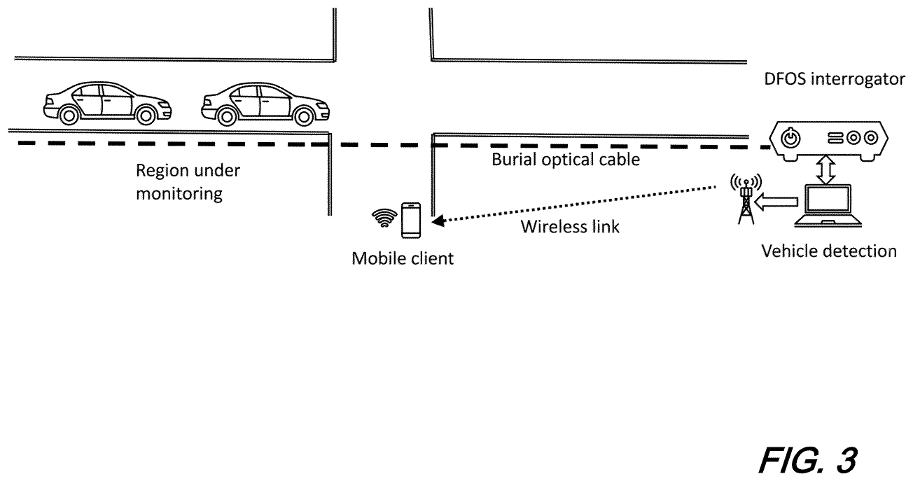

FIG. 3 is a schematic diagram showing an application scenario at an intersection according to aspects of the present invention.

With reference to this figure, it may be observed that a roadway intersection is shown monitored by a buried optical sensor fiber/cable in as part of a DFOS system. The intersection is shown with two vehicles traversing a portion of the roadway region being monitored by the DFOS system, and a mobile client vehicle, the mobile client vehicle in wireless communication with the vehicle detection system which in turn is in communication with the DFOS system/interrogator/analyzer.

As those skilled in the art will understand and appreciate, first-generation DFOS was employed in which the ‘waterfall’ plot snapshot is the data source for a downstream AI engine for event detection and classification. Such first-generation systems provided up to 32,000 sensing points for monitoring vibrational activity along the length of the optical sensing fiber. However, the system's temporal resolution was limited due to throughput constraints, resulting in reduced capability to capture detailed dynamic vents.

As a result, while these first-generation systems could detect and localize vibration along the optical sensor fiber, they experienced significant difficulties in classifying the source or category of mechanical disturbances vibrationally impacting the optical sensor fiber. In sharp contrast, with our inventive HD-DFOS, the fiber sensing interrogator can capture vibration patterns at a much higher temporal resolution. In this context, we define high-definition DFOS data as the ability to capture thousands of frames per second of vibrational signals, as compared to only a few frames per second of vibration intensity in the previous generations of DFOS systems. This substantial increase in temporal resolution allows for clear identification of vibrational signatures associated with different sources.

Vehicles, for instance, generate distinct vibrational patterns, which can now be more easily detected and classified using machine learning (ML) algorithms. This represents a significant improvement over the first generation DFOS, which struggled with low temporal resolution data, making it difficult to differentiate between vehicle-induced vibrations and other ambient ground disturbances.

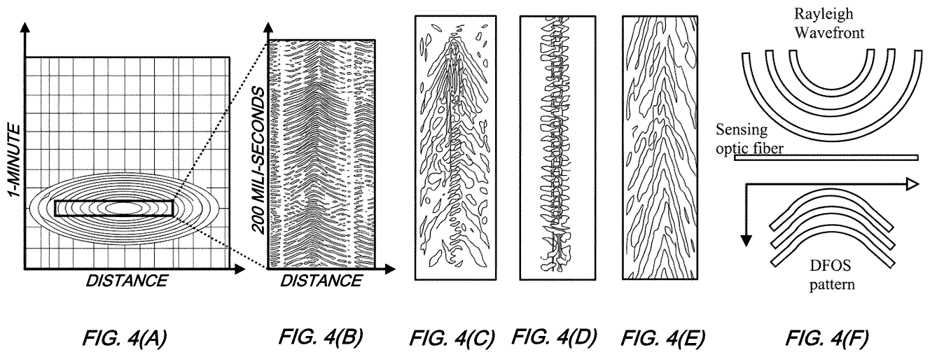

FIG. 4(A), FIG. 4(B), FIG. 4(C), FIG. 4(D), FIG. 4(E), and FIG. 4(F) show received vehicle traces from two DFOS system in which: a pair of reliability diagrams in which: FIG. 4(A) a waterfall plot of vehicle trace with low temporal resolution; FIG. 4(B) is a trace of the same vehicle from a high-definition DFOS; FIG. 4(C) is a pounding ground snapshot; FIG. 4(D) is a continuous hammer drill action snap shot; FIG. 4(E) is a zoomed in pattern of vehicle passing, and FIG. 4(F) is a Rayleigh wavefront model and resulting DFOS pattern all according to aspects of the present disclosure.

As shown in these figures, FIG. 4(A) shows typical sensing signals received from first-generation DFOS, which offers lower temporal resolutions while FIG. 4(B) displays the traces from the same vehicle captured using HD-DFOS, providing significantly more sensing information, where the wavefront of ground vibration is clearly visible.

The snapshots of the high definition DFOS pattern are shown having the horizontal axis representing the distance along the optical sensor fiber, and the vertical axis representing time.

FIG. 4(A) shows the “waterfall” plot of a vehicle operating along a roadway adjacent to an underground fiber optic cable, while FIG. 4(D) is the high-definition DFOS pattern for the same vehicle. The wavefront of a surface wave caused by the vehicle can be clearly seen in the high-definition DFOS pattern due to a much higher temporal resolution. For the “waterfall” recording, the refresh rate is about 8 frames per second while for the high-definition DFOS it is substantially 1000 frames per second for the raw waveform image.

A few snap shots of different vibration sources are also shown in this figure. FIG. 4(C) shows the pattern generated by pounding the ground with a tamper, FIG. 4(D) shows the pattern generated by a continuous hammer drill, FIG. 4(E) shows the pattern of an illustrative vehicle trace.

As may be apparent, there are some similarities between the different source types and they all show feather-like features. These phenomena can be explained as follows. Any source with vertical action will mainly generate a Rayleigh wave, which is one type of surface wave for ground movement. For a point source, the wave front is a group of cycles with a common center on the source location, FIG. 4(F) indicates the propagation of Rayleigh waves and the optical sensor fiber response detected by DFOS. Activities like vehicles operating, equipment digging, etc., will typically generate this type of surface wave.

However, due to the different frequencies of those actions and resulting DFOS patterns, we advantageously can classify the source of the actions. For example, a vehicle moving generates a lower pitch than construction machinery operations such as a hammer drill. Impulse sources including pounding and digging typically generate dispersive waves due to their aperiodic features.

As we have noted, we applied a YOLO (You Only Look Once) object detection algorithm to distinguish vehicle-induced vibration patterns from other ambient ground vibrations. Additionally, the same algorithm is employed to detect events where vehicles cross the road surface defects, such as potholes or cracks, etc.

A 2016 Computer Vision and Pattern Recognition paper entitled “You Only Look Once: Unified, Real-Time Object Detection”, authored by Joseph Redmon, Santosh Divvala, Ross Girshick, and Ali Farhadi, that appeared in 2016 IEEE Conference on Computer Vision and Pattern Recognition, at pg. 779-788, in 2016, represented a significant advance in computer vision. It fundamentally shifted object detection away from complex, multi-stage pipelines toward a single, end-to-end differentiable neural network. The entire contents of this paper is incorporated by reference into this application as if set forth at length.

Here is a comprehensive summary of the original YOLO algorithm (often referred to retrospectively as YOLOv1) exactly as detailed in that foundational paper.

### The Paradigm Shift: Detection as Regression

Prior to YOLO, the state-of-the-art systems like R-CNN used region proposal methods to generate potential bounding boxes, ran a classifier on those proposed boxes, and then used post-processing to refine the boxes and eliminate duplicates. This multi-stage pipeline was slow and difficult to optimize because each component had to be trained separately.

Redmon et al. reframed object detection as a single regression problem, straight from image pixels to bounding box coordinates and class probabilities. A single convolutional network predicts multiple bounding boxes and class probabilities simultaneously.

### The Grid System and Representation

YOLO divides the input image into an S×S grid (in the paper, S=7).
The Golden Rule: If the center of an object falls into a specific grid cell, that grid cell is exclusively responsible for detecting that object.
Each grid cell predicts B bounding boxes (in the paper, B=2) and confidence scores for those boxes.
Confidence Score: This score reflects how confident the model is that the box contains an object, and how accurate it thinks the box is. It is formally defined as Pr(Object)*IOU_{pred}^{truth} (Intersection over Union between the predicted box and the ground truth).
Each bounding box consists of 5 predictions: x, y, w, h, and confidence. The (x, y) coordinates represent the center of the box relative to the bounds of the grid cell. The width and height (w, h) are predicted relative to the whole image.
Class Probabilities: Each grid cell also predicts C conditional class probabilities, Pr(Classᵢ|Object). Note that YOLOv1 predicts one set of class probabilities per grid cell, regardless of the number of boxes B.

For evaluation on the PASCAL VOC dataset, using S=7, B=2, and C=20, the final prediction is a 7×7×30 tensor.

### Network Architecture

The YOLO network architecture was inspired by the GoogLeNet model for image classification.
It features 24 convolutional layers followed by 2 fully connected layers.
Instead of the complex inception modules used by GoogLeNet, YOLO simply uses 1×1 reduction layers followed by 3×3 convolutional layers.
The convolutional layers extract features from the image, while the fully connected layers predict the output probabilities and coordinates.
A faster version, “Fast YOLO,” used a neural network with fewer convolutional layers (9 instead of 24) and fewer filters, pushing the speed to 155 frames per second.

### The Loss Function Design

To train the network, the authors used a multi-part sum-squared error loss function. However, they had to introduce specific weighting parameters to balance the loss effectively:
Class Imbalance: Most grid cells in an image do not contain an object. If all cells were treated equally, the “confidence” scores of these empty cells would push towards zero, overpowering the gradient from cells that actually contained objects and causing instability.
The Fix: They increased the loss from bounding box coordinate predictions (λ_{coord}=5) and decreased the loss from confidence predictions for boxes that don't contain objects (λ_{noobj}=0.5).
Scale Sensitivity: Sum-squared error weights errors in large boxes and small boxes equally. However, a small error in a small bounding box is much more detrimental than a small error in a large bounding box. To address this, YOLO predicts the square root of the bounding box width and height instead of the raw width and height.

### Key Strengths Demonstrated

Extreme Speed: Because the pipeline is a single network evaluation, YOLO is incredibly fast, achieving 45 FPS on a standard Titan X GPU, making real-time processing viable.
Global Context: Unlike sliding window or region proposal-based techniques, YOLO sees the entire image during training and test time. This allows it to implicitly encode contextual information about classes and their appearances. Consequently, YOLO makes less than half the number of “background errors” (false positives where background is mistaken for an object) compared to Fast R-CNN.
Generalization: YOLO learns highly generalizable representations of objects, outperforming systems like DPM and R-CNN when applied to new domains (e.g., training on natural images and testing on artwork).

### Inherent Limitations of the v1 Architecture

The paper is transparent about the algorithm's flaws:
Spatial Constraints: Because each grid cell only predicts two boxes and can only have one class, YOLOv1 imposes strong spatial constraints. It severely struggles with small objects that appear in groups (like a flock of birds).
Aspect Ratios: It struggles to generalize to objects in new or unusual aspect ratios or configurations that it did not see during training.
Localization Errors: While YOLO makes fewer background errors than Fast R-CNN, it struggles more with precise localization (getting the bounding box boundaries exactly right), particularly for small objects.

### Inherent Limitations of the v1 Architecture

For training the YOLO model, we convert the monotonic temporal-spatial vibrational pattern to 2d pseudo color image we cropped and label the snapshot. For the repetition of 1000 Hz and 4000 sensing channels, the inference time is less than 10 ms second for scanning a frame of 500×4000 patch. This size represents 0.5 second duration. The speed performance can meet real-time requirement for the intersection monitoring.

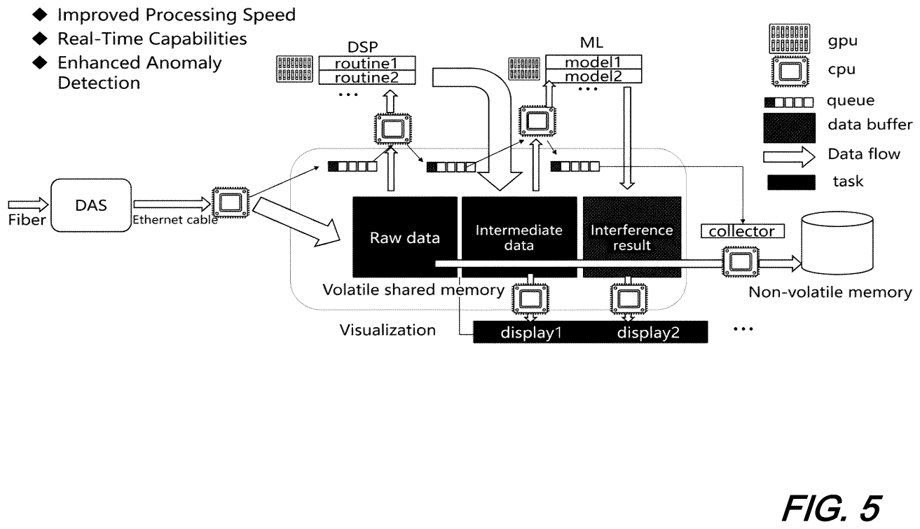

FIG. 5 is a schematic diagram showing an illustrative software architecture for high definition DFOS streaming and detection according to aspects of the present invention.

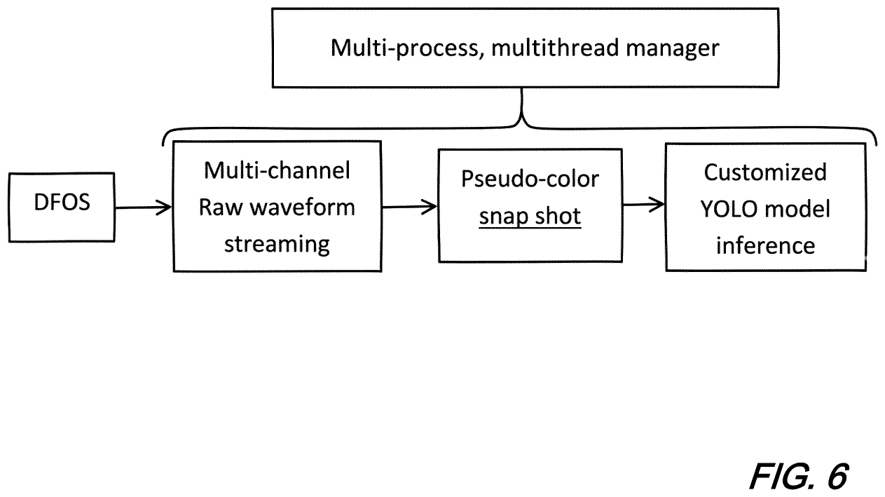

FIG. 6 is a schematic diagram showing illustrative data processing pipeline according to aspects of the present invention.

As illustratively shown, the DFOS system receives DFOS phase variation data from an optical sensing fiber which resulted from that fiber experiencing vibrational activities along the fiber due to vibration, and transfers it via Ethernet to volatile shared memory, where multiple data stages are stored, starting with raw DAS data.

Various processes, such as DSP and display, access early-stage data and share their results in an intermediate stage for further analysis or visualization. Machine Learning (ML) processes can utilize this data, producing results including anomaly detection, which are stored for further use. Advantageously, multiple tasks can run simultaneously, with multiple displays presenting results in real-time. Communication between processes occurs through designated message queues, ensuring fast and efficient data exchange. This flexible pipeline facilitates seamless and rapid processing across multiple stages.

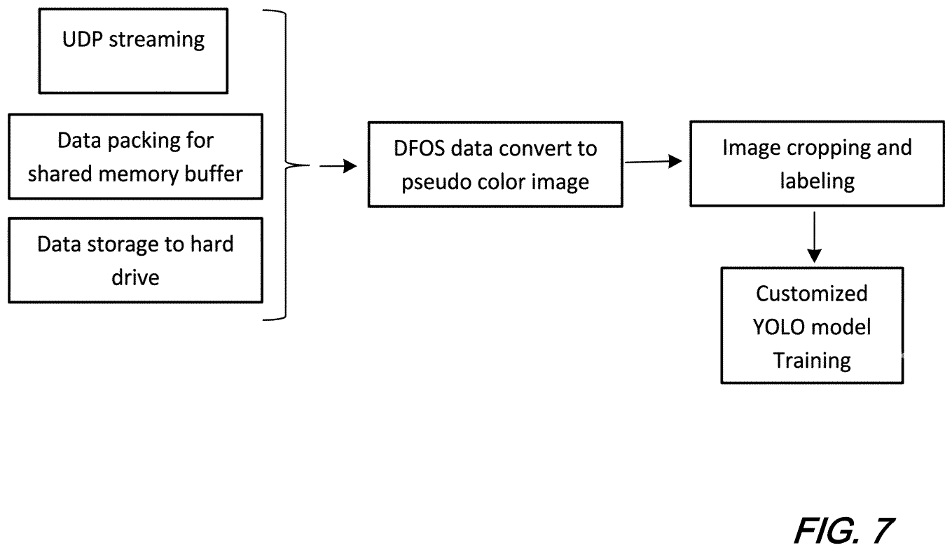

FIG. 7 is a schematic diagram showing illustrative model training according to aspects of the present invention.

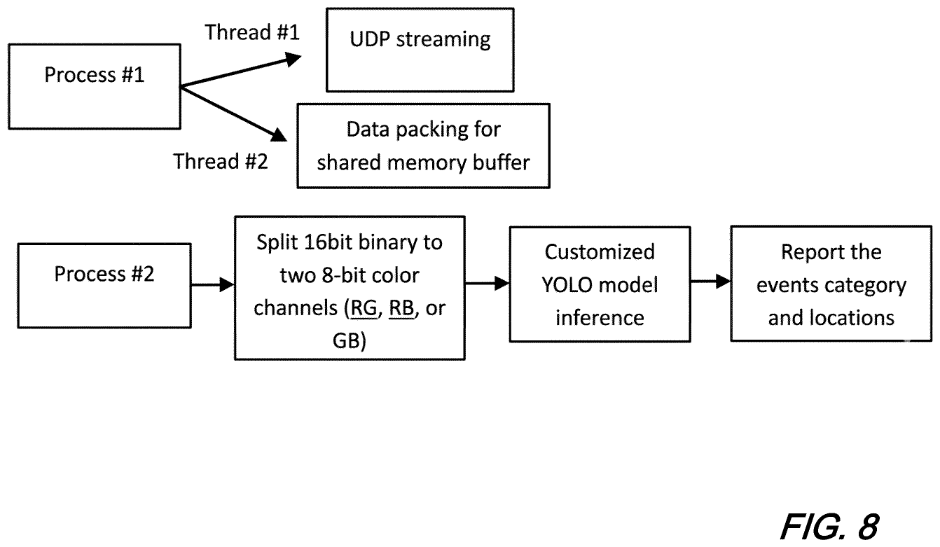

FIG. 8 is a schematic diagram showing illustrative real-time event detection framework according to aspects of the present invention.

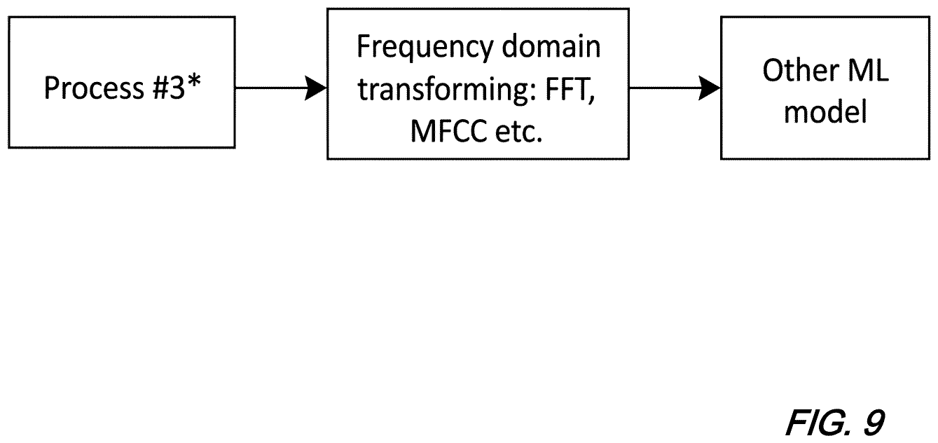

FIG. 9 is a schematic diagram showing illustrative model training according to aspects of the present invention. As illustratively shown in this figure, in addition to using a direct-use vibration wave front pattern to train the YOLO model, we extract the temporal-frequency feature as input to train the classifier. For example, multi-channel vibration signals are converted to Mel-frequency cepstral coefficients (MFCCs), and we subsequently use MFCC snap shots to train the classifier.

At this point, those skilled in the art will understand that while we have presented our inventive concepts and description using specific examples, our invention is not so limited. Accordingly, the scope of our invention should be considered in view of the following claims.

1. A high-definition distributed fiber optic sensing (HD-DFOS) system for smart intersection traffic monitoring and diagnostics, comprising:
an optical fiber deployed along a roadway;
an interrogator coupled to the optical fiber configured to capture vibrational signals at a temporal resolution of at least one thousand frames per second;
a computational platform configured to receive data streaming from the interrogator, wherein the computational platform converts 16-bit digitized, multi-channel transient traces from the vibrational signals into 2D pseudo-color RGB images; and
a YOLO (You Only Look Once) object detection model trained on cropped patterns from the pseudo-color RGB images to classify the source of mechanical disturbances in real-time.

2. The system of claim 1, wherein the object detection model distinguishes vehicle-induced vibration patterns from ambient ground vibrations.

3. The system of claim 2, wherein the object detection model detects events where a vehicle crosses a road surface defect.

4. The system of claim 3, wherein the road surface defect is a pothole or a crack.

5. The system of claim 1, wherein the computational platform further comprises a multi-process and multi-thread manager, and a volatile shared memory buffer.

6. The system of claim 5, wherein the volatile shared memory buffer stores raw data, intermediate data, and interference results accessed via designated message queues.

7. The system of claim 1, wherein the object detection model is configured to classify sources of vertical actions generating Rayleigh waves.

8. The system of claim 1, wherein the system broadcasts the locations of detected road defects to vehicles using blockchain technology.

9. A method for detecting and classifying traffic and road conditions, the method comprising:
capturing high-definition distributed fiber optic sensing (HD-DFOS) data along an optical fiber at a rate of at least 1000 frames per second;
transferring the captured data via Ethernet to a volatile shared memory buffer;
converting tempo-spatial plots of the captured data into pseudo-color images; and
applying a YOLO machine learning algorithm to the pseudo-color images to detect and localize specific vibrational events in real-time.

10. The method of claim 9, further comprising extracting temporal-frequency features from the data by converting multi-channel vibration signals into Mel-frequency cepstral coefficients (MFCCs) to train a classifier.
